(19) United States
(12) Patent Application Publication
(10) Pub. No.: US 2025/0303613 A1
(43) Pub. Date: Oct. 2, 2025

(54) SYSTEM AND METHOD FOR SLICING WORKPIECE

(71) Applicant: COMPTAKE TECHNOLOGY INC., NEW TAIPEI CITY (TW)

(72) Inventors: ZHI-WEN FAN, NEW TAIPEI CITY (TW); JUN-CHANG WEN, NEW TAIPEI CITY (TW); CHENG-YANG CHEN, NEW TAIPEI CITY (TW)

(21) Appl. No.: 18/623,058

(22) Filed: Apr. 1, 2024

(51) Int. Cl. B28D 5/04

(52) U.S. Cl. CPC B28D 5/045

(57) ABSTRACT

A slicing system is provided. The system includes: a holding assembly defining an interior space for receiving a workpiece; an inlet port and an outlet port communicating with the interior space; at least one cutting member configured to move relative to the holding assembly so as to slice the workpiece positioned in the interior space; an electrolyte source connected to the inlet port, wherein an electrolyte is supplied from the electrolyte source to the interior space through the inlet port and existing the interior space through the outlet port; and a power supply module configured to apply an electric current to the at least one cutting member and to the holding assembly.

### FIELD OF THE INVENTION

Embodiments of present disclosure relate to a system and a method for slicing workpiece through electrochemical machining technique.

### BACKGROUND

As semiconductor devices continue pushing the boundaries, there is an ever-increasing demand for improved wafer production processes that can reliably manufacture high-quality wafers from robust materials in an efficient and cost-effective manner. Certain modern materials like silicon carbide (SiC) and conductive ceramics such as aluminum nitride (AlN) possess exceptional properties including high thermal conductivity, strong electric fields, and high current carrying capabilities. However, transforming ingots or boules of these materials into wafers suitable for device fabrication remains a significant challenge.

The conventional approach widely used in the industry for slicing ingots into wafers is wire sawing. This mechanical technique employs a wire to cut through and section the ingot into thin wafer pieces. While wire sawing has been successfully utilized, it faces numerous limitations that can negatively impact wafer quality, production yields, and manufacturing economics across various materials, including extremely hard and chemically inert materials like SiC and AlN. Issues associated with wire sawing of robust materials comprise significant material loss due to the kerf width of the cutting wire, surface damage such as micro-cracks induced by the mechanical cutting action, and difficulties in maintaining tight total thickness variation (TTV) control.

It would be desirable to develop methods of ingot slicing that avoided some or all of the above-discussed problems.

### SUMMARY OF THE INVENTION

The present invention provides a transformative electrochemical sawing process that can be advantageously applied to slicing ingots of various robust materials, including but not limited to SiC and AlN. This newly developed technique addresses the issues faced by conventional wire sawing approaches.

One aspect of the present disclosure provides a slicing system. The system includes: a holding assembly defining an interior space for receiving a workpiece; an inlet port and an outlet port communicating with the interior space; at least one cutting member configured to move relative to the holding assembly so as to slice the workpiece positioned in the interior space; an electrolyte source connected to the inlet port, wherein an electrolyte is supplied from the electrolyte source to the interior space through the inlet port and existing the interior space through the outlet port; and a power supply module configured to apply an electric current to the at least one cutting member and to the holding assembly.

In some embodiments, a width of the inlet port is greater than a width of the outlet port, and a pressure inside the interior space becomes greater than a pressure at the inlet port when the interior space is filled with the electrolyte.

In some embodiments, the holding assembly includes a front wall and a rear wall arranged along a longitudinal axis, the inlet port and the outlet port are positioned on the front wall and the rear wall, respectively. The outlet port is arranged offset from the longitudinal axis and is positioned higher than the inlet port. Alternatively, the outlet port the inlet port and the outlet port are arranged aligning with the longitudinal axis.

In some embodiments, the holding assembly comprises at least one supporting structure positioned within the interior space and configured to support the workpiece in the interior space. The interior space of the holding assembly is defined by an inner wall, and the number of the supporting structures is plural, wherein each of the supporting structures is arranged on the inner wall and extends along a longitudinal axis. The supporting structures are spaced apart in a circumferential direction of the inner wall at a constant pitch

In some embodiments, when the workpiece is positioned in the interior space, at least a portion of the holding assembly is positioned between the at least one cutting member and the workpiece.

In some embodiments, the cutting member includes a wire having a circular cross-section. The number of cutting members is plural, and the wires are arranged parallel to each other.

Another aspect of the present disclosure, a slicing method is provided. The method includes loading a workpiece into an interior space of a holding assembly; supplying an electrolyte to the interior space through an inlet port and discharging the electrolyte through an outlet port; slicing the workpiece by at least one cutting member; and applying an electric current to the at least one cutting member and to the workpiece.

In some embodiments, a flow rate of the electrolyte through the outlet port is smaller than a flow rate of the electrolyte through the inlet port, and a higher pressure is established inside the interior space when the electrolyte is supplied into the interior space.

In some embodiments, the electrolyte exits the interior space via the outlet port which is positioned higher than the inlet port.

In some embodiments, the method further includes slicing a side wall of the holding assembly before slicing the workpiece, and/or includes slicing a side wall of the holding assembly while slicing the workpiece.

In some embodiments, the workpiece comprises a cylindrical ingot extending along a longitudinal axis, and the ingot is supported by a plurality of supporting structures surrounding a circumferential direction of the ingot and extending along the longitudinal axis.

In some embodiments, the workpiece is sliced by the cutting member including a wire having a circular cross-section.

According to the present disclosure, the application of electrochemical machining (cutting) process in slicing workpiece enables reduced material loss, improved surface quality, superior total thickness variation control, higher throughput, minimized environmental impact, and lower energy consumption compared to mechanical sawing processes.

The above summary is not intended to describe each illustrated embodiment or every implementation of the present disclosure.

### BRIEF DESCRIPTION OF THE DRAWINGS

Aspects of the embodiments of the present disclosure are best understood from the following detailed description when read with the accompanying figures. It is noted that, in accordance with the standard practice in the industry, various structures are not drawn to scale. In fact, the dimensions of the various structures may be arbitrarily increased or reduced for clarity of discussion.

FIG. 1 shows a schematic view of a slicing system, in accordance with one or more embodiments of the present disclosure.

FIG. 2 shows an exploded view drawing of a holding assembly with a workpiece positioned therein, in accordance with one or more embodiments of the present disclosure.

FIG. 3 shows a schematic cross-sectional view of a holding assembly with a workpiece positioned therein, in accordance with one or more embodiments of the present disclosure.

FIG. 4 shows a schematic view of a holding assembly, in accordance with one or more embodiments of the present disclosure.

FIG. 5 shows a schematic cross-sectional view of a holding assembly with a workpiece positioned therein, in accordance with one or more embodiments of the present disclosure.

FIG. 6 shows a schematic cross-sectional view of a holding assembly with a workpiece positioned therein, in accordance with one or more embodiments of the present disclosure.

FIG. 7 shows a flow chart illustrating a method for slicing a work piece, in accordance with various aspects of one or more embodiments of the present disclosure.

FIG. 8 shows a schematic view illustrating one stage of a method of performing a work piece slicing process at which sawing lines cut side walls of a holding assembly, in accordance with one or more embodiments of the present disclosure.

FIG. 9 shows a schematic view illustrating one stage of a method of performing a work piece slicing process at which sawing lines cut side walls of a holding assembly as well as a workpiece, in accordance with one or more embodiments of the present disclosure.

FIG. 10 shows a schematic view illustrating one stage of a method of performing a work piece slicing process at which sawing lines cut side walls of a holding assembly after slicing a workpiece, in accordance with one or more embodiments of the present disclosure.

FIG. 11 shows a schematic view of a sliced work piece held by a sliced holding assembly, in accordance with one or more embodiments of the present disclosure.

### DETAILED DESCRIPTION

The following detailed description should be read with reference to the drawings in which similar elements in different drawings are numbered the same. The detailed description and the drawings, which are not necessarily to scale, depict illustrative embodiments and are not intended to limit the scope of the invention. The illustrative embodiments depicted are intended only as exemplary. Selected features of any illustrative embodiment may be incorporated into an additional embodiment unless clearly stated to the contrary.

The terminology used in this specification is intended to describe particular embodiments and is not intended to be limiting. The terms “a,” “an,” and “the” include the plural forms as well, unless clearly indicated otherwise. The terms “comprises,” and/or “includes,” when used in this specification, specify the presence of the stated features, integers, steps, operations, elements, and/or components, but do not preclude the presence or addition of one or more other features, integers, steps, operations, elements, and/or components.

Further, spatially relative terms, such as “beneath,” “below,” “lower,” “above,” “over,” “upper,” “on,” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

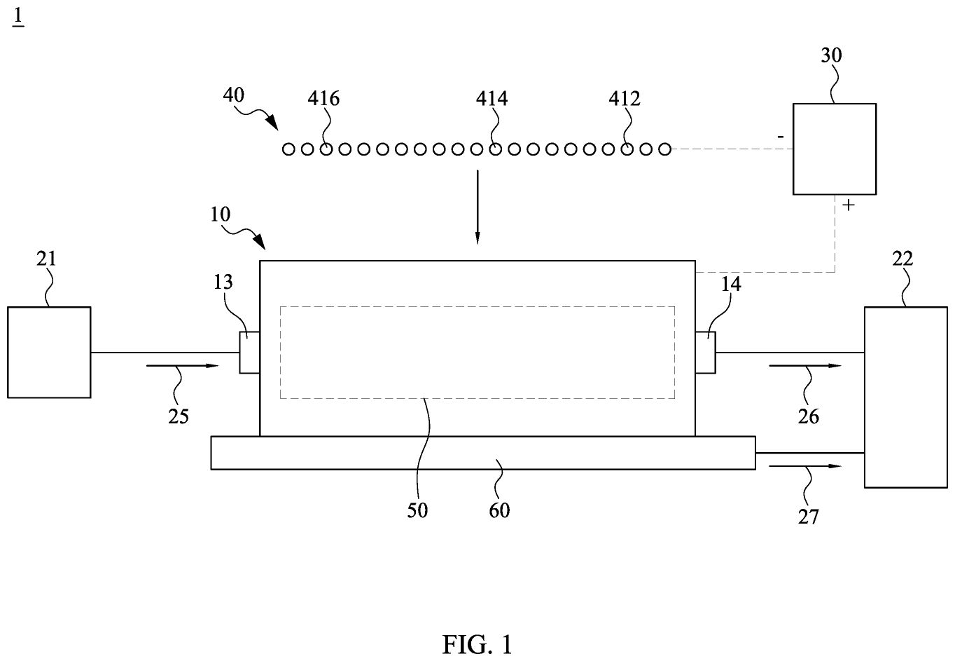

FIG. 1 shows a schematic view of a slicing system 1, configured to perform slicing of a workpiece 50 using an electrochemical machining process, in accordance with one or more embodiments of the present disclosure. The slicing process is performed to slice the ingot into thin wafers for subsequent fabrication processes.

In some embodiments, the workpiece 50 can include various materials such as metals, semiconductors, or other conductive materials. For example, in some embodiments, the workpiece is a metal ingot or boule. In other embodiments, the workpiece is a semiconductor ingot or boule made of a wide-bandgap semiconductor compound. The semiconductor ingot may have a cylindrical shape and extend along its longitudinal axis. Example semiconductor compounds that may be used include, but are not limited to, silicon carbide (SiC) or aluminum nitride (AlN). In one exemplary embodiment, the workpiece 50 to be sliced is made of silicon carbide (SiC) or aluminum nitride (AlN). Before the slicing process, a doping process is performed to control the electrical properties of the workpiece 50. One exemplary doping process for the SiC ingot includes doping agents, which are typically elements like nitrogen (N) for n-type or aluminum (Al) for p-type doping, introduced into the gas phase during growth of a SiC crystal. As the SiC crystal begins to form, these dopant atoms are incorporated into the crystal lattice. The concentration of the dopants in the gas phase and the growth conditions (such as temperature and pressure) are precisely controlled to achieve the desired level of doping within the ingot. The electrical properties of the SiC crystal may be affected by the dopant concentration. It should be understood that the system of the present disclosure is not limited to processing semiconductor materials, but can also be used to process any conductive material.

The slicing system 1, in accordance with some embodiments, includes a holding assembly 10, an electrolyte source 21, an electrolyte handling assembly 22, a power supply module 30, a cutting tool 40, and a tank 60.

The electrolyte source 21 is fluidly connected to an inlet port 13 of the holding assembly 10 and is configured to supply an electrolyte 25 to the holding assembly 10 used in the workpiece slicing process. The electrolyte handling assembly 22 is fluidly connected to an outlet port 14 of the holding assembly 10 and is configured to process a waste fluid 26 discharged from the holding assembly 10. The tank 60 is positioned below the holding assembly 10 and configured to collect the waste liquid leaking from the holding assembly 10 during the workpiece slicing process. The waste liquid 27 collected by the tank 60 may be delivered to the electrolyte handling assembly 22. The electrolyte handling assembly 22 may include a filter to remove residues in the waste liquid 26 or 27. In one exemplary embodiment, the electrolyte processed by the electrolyte handling assembly 22 may be circulated back to the holding assembly 10 for reuse in order to reduce manufacturing costs.

The cutting tool 40 is configured to slice the workpiece 50 positioned in the holding assembly 10. In some embodiments, the cutting tool 40 includes a number of cutting members, such as cutting members 412, 414, and 416. In some embodiments, the cutting member 412, 414, and 416 include wires having a circular cross-section with a very fine diameter. For purpose of description, hereinafter the cutting member also refer to as wires. The wires 412, 414, and 416 may be made of stainless steel and are free of abrasive material such as diamond or silicon carbide particles. In some embodiments, as shown in FIG. 1, the wires 412, 414, and 416 are arranged parallel to each other, allowing for multiple wafers to be sliced simultaneously. The cutting tool 40 may include a spooling system including a supply reel and a take-up reel for proper disposal or recycling of the used wire. The wire is spooled from the supply reel and taken up on the take-up reel after passing through the ingot. In addition, the cutting tool 40 may include a number of guiding rollers connected to the wires 412, 414, and 416. The guiding rollers are configured to maintain tension and guide the wire downward in a controlled path through the ingot. However, the present invention is not limited to the embodiment. In one alternative embodiment, the cutting tool 40 includes one or more blades. The blades are driven to move downward to cut through the holding assembly 10 and the workpiece 50 to slice the workpiece 50.

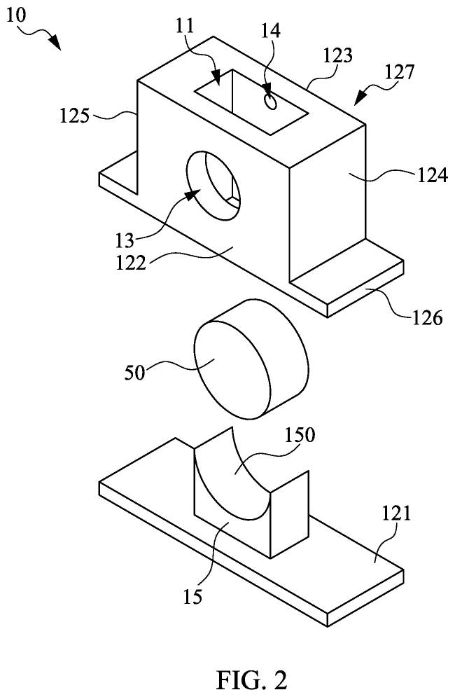

FIG. 2 shows an exploded view drawing of the holding assembly 10 with a workpiece positioned therein, in accordance with one or more embodiments of the present disclosure. According to one exemplary embodiment, the holding assembly 10 includes a base 121, a front wall 122, a rear wall 123, a first lateral wall 124, a second lateral wall 125, two flanges 126, and a supporting structure 15. The supporting structure 15 is fixed on a top surface of the base 121 and is configured to support the workpiece 50. The supporting structure 15 may have a curved top surface 150 which has a curvature corresponding to that of the outer surface of the workpiece 50. When the workpiece 50 is positioned on the supporting structure 15, the outer surface of the workpiece 50 smoothly contacts the top surface 150 of the supporting structure 15. An adhesive (not shown in figures) may be applied on the top surface 150 before loading the workpiece 50 to assist in fixing the workpiece 50.

The front wall 122, the rear wall 123, the first lateral wall 124, the second lateral wall 125, and the flange 126 cooperatively form a movable cover 127. The movable cover 127 can be detached from the base 121 when the workpiece 50 is loaded on the supporting structure 15. The front wall 122 is opposite to the rear wall 123. The first lateral wall 124 is opposite to the second lateral wall 125. The first lateral wall 124 and the second lateral wall 125 are connected between the front wall 122 and the rear wall 123. An interior space 11 of the holding assembly 10 is defined by the top surface of the base 121, the front wall 122, the rear wall 123, the first lateral wall 124, and the second lateral wall 125. The supporting structure 15 and the workpiece 50 positioned on the supporting structure 15 may be received in the interior space 11 when the movable cover 127 is detached from the base 121. The two flanges 126 are connected to lower edges of the outer surface of the first lateral wall 124 and the second lateral wall 125. The movable cover 127 may be fixed onto the base 121 by connecting the two flanges 126 and the base 121 through suitable means, such as welding or fastening.

In some embodiments, the base 121, the movable cover 127, and the supporting structure 15 are made of conductive material, such as aluminum, conductive plastic. The power supply module 30 is electrically connected to the base 121, the movable cover 127, and the supporting structure 15. When the workpiece 50 is mounted on the supporting structure 15, electrical current is transmitted to the workpiece 50 through the base 121, the movable cover 127, and the supporting structure 15.

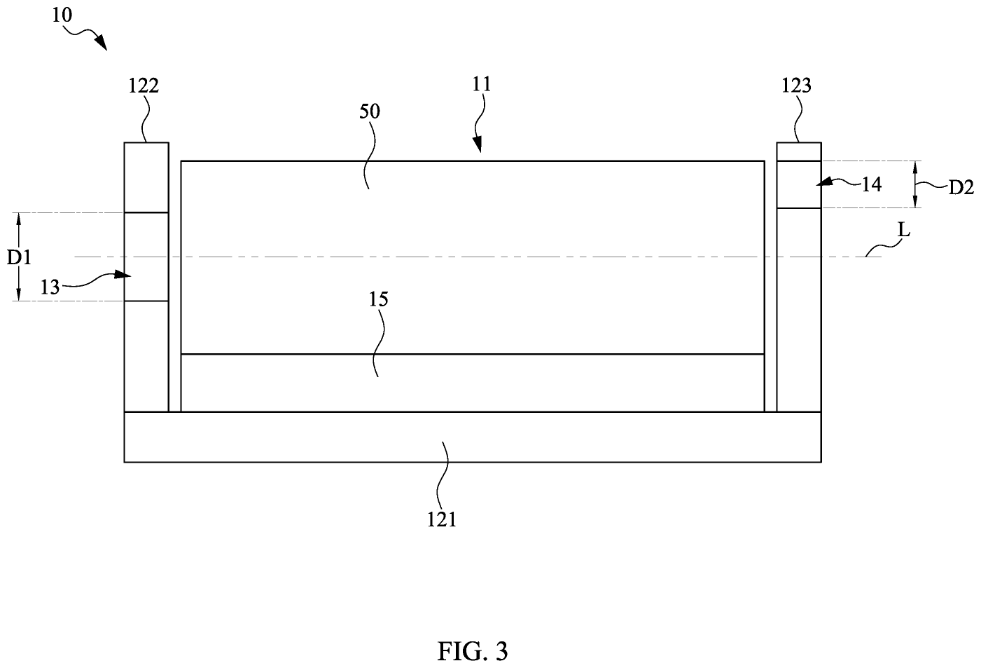

The inlet port 13 is formed on the front wall 122, and the outlet port 14 is formed on the rear wall 123. The inlet port 13 and the outlet port 14 communicate with the interior space 11. Electrolyte provided from the electrolyte source 21 (FIG. 1) enters the interior space 11 through the inlet port 13 and exits the interior space 11 through the outlet port 14. As shown in FIG. 3, the inlet port 13 is positioned aligning a longitudinal axis L of the workpiece 50 when the workpiece 50 is positioned on the supporting structure 15. The outlet port 14 is positioned offset from the longitudinal axis L of the workpiece 50 and is positioned higher than the inlet port 13 relative to the base 121. In one exemplary embodiment, the outlet port 14 is located higher than the workpiece 50 when the workpiece 50 is positioned on the supporting structure 15. With the outlet port 14 arranged higher than the inlet port 13, the workpiece 50 in the interior space 11 can be entirely immersed in the electrolyte.

In some embodiments, the dimension of the inlet port 13 is different from the dimension of the outlet port 14. For example, the inlet port 13 has a width (or diameter) D1, and the outlet port 14 has a width (or diameter) D2. The width D1 is greater than the width D2. In one exemplary embodiment, a ratio between the width D1 and the width D2 is greater than 2. In some alternative embodiment, the ration is from about 5 to about 10. Since the outlet port 14 has a lower flow rate than the inlet port 13 due to its smaller size, which causes the liquid level in the interior space 11 to increase during constant supplying of electrolyte into the interior space 11.

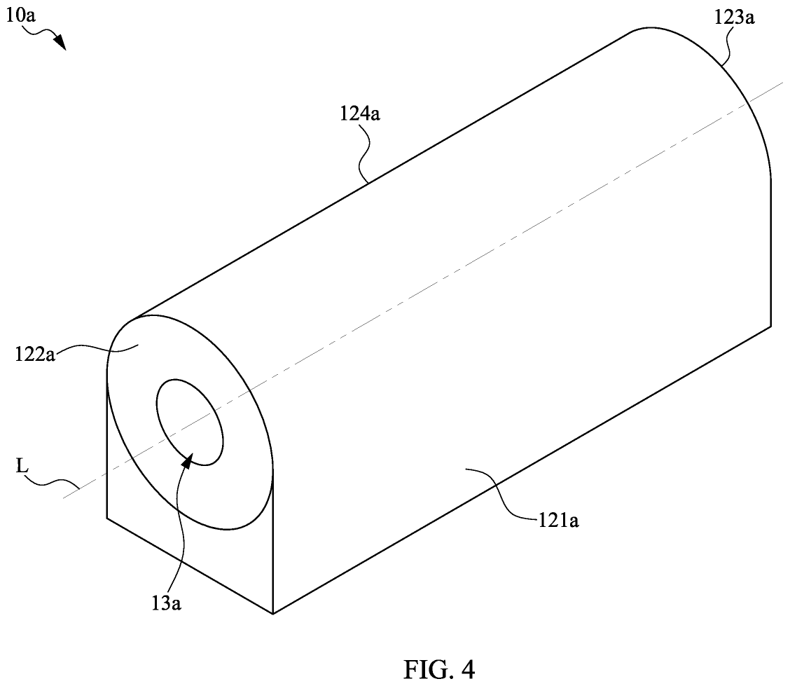

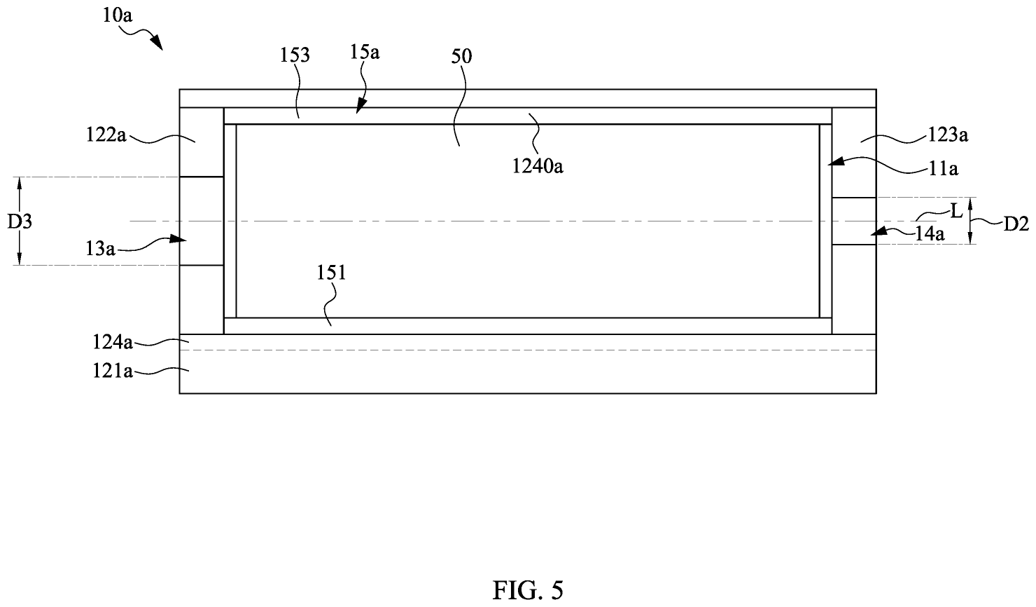

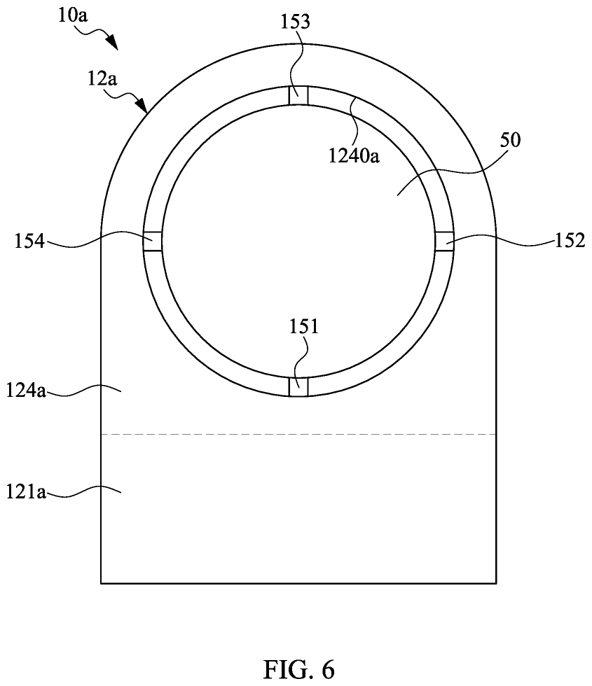

FIG. 4 shows a schematic view of a holding assembly 10a, FIG. 5 shows a schematic cross-sectional view of the holding assembly 10a taken along a longitudinal axis L of the workpiece 50, FIG. 6 shows a schematic cross-sectional view of the holding assembly 10a taken along a traversal direction which is perpendicular to the longitudinal axis L of the workpiece 50, in accordance with one or more embodiments of the present disclosure. According to one exemplary embodiment, the holding assembly 10a includes a base 121a, a front wall 122a, a rear wall 123a, and an upper holder 124a.

The upper holder 124a is positioned on the base 121a. The upper holder 124a is a hollowed structure with an arcuate top surface, and an inner wall 1240a which has a circular-shaped. The inner wall 1240a extends along a longitudinal direction of the holding assembly 10a. The front wall 122a and the rear wall 123 are detachably connected to two ends of the inner wall 1240a of the upper holder 124a. When the front wall 122a and the rear wall 123 are connected to the upper holder 124a, an interior space 11a of the holding assembly 10a, which is airtight, is defined by the inner wall 1240a, the front wall 122a and the rear wall 123.

The inlet port 13a is formed on the front wall 122a, and the outlet port 14a is formed on the rear wall 123a. The inlet port 13a and the outlet port 14a communicate with the interior space 11a. Electrolyte provided from the electrolyte source 21 (FIG. 1) enters the interior space 11a through the inlet port 13a and exits the interior space 11a through the outlet port 14a. As shown in FIG. 5, the inlet port 13a and the outlet port 14a are positioned aligning the longitudinal axis L of the workpiece 50 when the workpiece 50 is positioned in the interior space 11a. In some other embodiments, the outlet port 14a is positioned offset from the longitudinal axis L of the workpiece 50 and is positioned higher than the inlet port 13a relative to the base 121a. With the outlet port 14 arranged higher than the inlet port 13, the workpiece 50 in the interior space 11 can be entirely immersed in the electrolyte.

In some embodiments, as shown in FIG. 6, the holding assembly 10a further includes a number of supporting structures, such as four supporting structures 151, 152, 153 and 154. Each of the supporting structures 151, 152, 153 and 154 is arranged on the inner wall 1240a and extends along the longitudinal axis L of the workpiece 50. The supporting structures 151, 152, 153 and 154 may be spaced apart in a circumferential direction of the inner wall 1240a at a constant pitch. When the workpiece 50 is positioned in the interior space 11a the outer surface of the workpiece 50 is directly contact with the supporting structures 151, 152, 153 and 154, and is distant away from the inner wall 1240a of the upper holder 124a. A number of elongated gaps are defined between the outer surface of the workpiece 50 and the inner wall 1240a of the upper holder 124a. These gaps allows the flow of electrolyte from the inlet port 13a to the outlet port 14a.

In some embodiments, the base 121a, the upper holder 124a, and the supporting structures 151, 152, 153 and 154 are made of conductive material, such as aluminum, conductive plastic. The power supply module 30 is electrically connected to t the base 121a, the upper holder 124a, and the supporting structures 151, 152, 153 and 154. When the workpiece 50 is mounted on the upper holder 124a, electrical current is transmitted to the workpiece 50 through the upper holder 124a, the supporting structures 151, 152, 153 and 154.

In some embodiments, the dimension of the inlet port 13a is different from the dimension of the outlet port 14a. For example, the inlet port 13a has a width (or diameter) D3, and the outlet port 14a has a width (or diameter) D4. The width D3 is greater than the width D4. In one exemplary embodiment, a ratio between the width D3 and the width D4 is greater than 2. In some alternative embodiment, the ration is from about 5 to about 10. Since the outlet port 14a has a lower flow rate than the inlet port 13a due to its smaller size, a backlog of fluid can occur. Therefore, when the interior space 11a is entirely filled with electrolyte, hydrostatic pressure in the interior space 11a increases above atmospheric pressure with any excess of inlet flow, which leads a pressure inside the interior space 11a becomes greater than a pressure at the inlet port 13a.

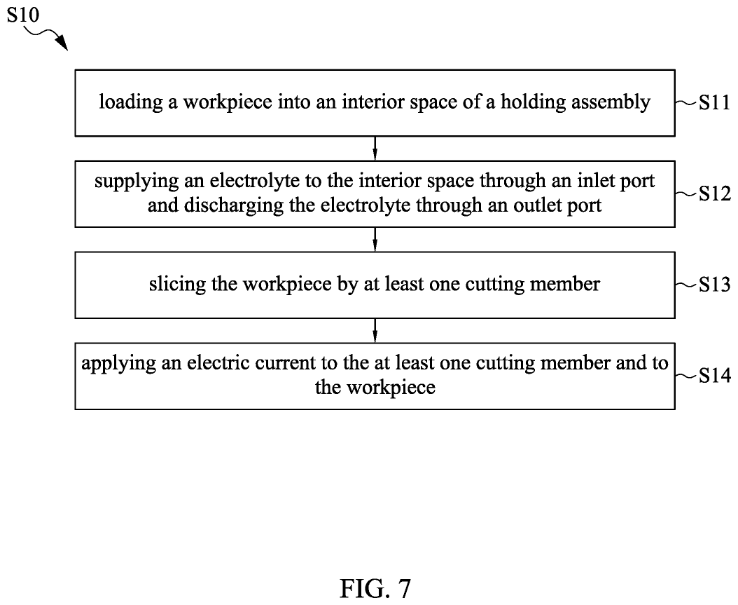

FIG. 7 shows a flow chart illustrating a method S10 for slicing a workpiece, in accordance with various aspects of one or more embodiments of the present disclosure. For illustration, the flow chart will be described along with the drawings shown in FIGS. 2-6 and 8-11. Some of the described stages can be replaced or eliminated in different embodiments.

The method S10 includes operation S11, in which a workpiece, such as semiconductor ingot, is loaded into the interior space of the holding assembly. In the embodiments shown in FIGS. 2-3, to load the workpiece 50 into the interior space 11, the movable cover 127 is first detached from the base 121. The workpiece 50 is mounted on the supporting structure 15. An adhesive (not shown in figures) may be applied on the top surface 150 before loading the workpiece 50 to assist in fixing it. After the workpiece 50 is placed on the supporting structure 15, the movable cover 127 is connected to the base 121 by suitable means, such as welding or fastening, so that the workpiece 50 is positioned within the interior space 11 of the holding assembly 10. In the embodiments shown in FIGS. 4-6, to load the workpiece 50 into the interior space 11a, one of the front wall 122a and the rear wall 123a is first removed from the upper holder 124a. The workpiece 50 is inserted into the interior space 11a of the holding assembly 10a by sliding along the longitudinal direction. During movement, the outer circumferential surface of the workpiece 50 is in direct contact with the supporting structures 151, 152, 153 and 154. After placing the workpiece 50 in the interior space 11a, the removed front or rear wall is moved back to the upper holder 124a to seal the interior space 11a.

The method S10 also includes operation S12, in which an electrolyte is supplied to the interior space through an inlet port and discharging the electrolyte through an outlet port. In the embodiments shown in FIGS. 2-3, the electrolyte 25 is supplied to the interior space 11 through the inlet port 13. Since the outlet port 14 is positioned higher than the inlet port 13 and higher than the workpiece 50, the electrolyte 25 will not exit through the outlet port 14 before the workpiece 50 is immersed. In the embodiments shown in FIGS. 4-6, the electrolyte 25 is supplied to the interior space 11a through the inlet port 13a. Due to the larger inlet port 13a dimensions compared to the outlet port 14a, an electrolyte 25 backlog occurs, and the outlet port 14a has a lower flow rate than the inlet port 13a. This backlog causes the pressure inside interior space 11a to become greater than atmospheric pressure. The higher pressure facilitates the electrolyte 25 feeding into cuts formed in the workpiece 50.

The electrolyte 25 may be a solution including commercially available electrolytes, such as inorganic salt solutions mixed with other components. Embodiments also contemplate using compositions with rust inhibitors and chelating agents. In one aspect, the electrolyte solution may have a temperature of 30-45° C. and a flow pressure of 35-70 KPa. Flow rate, pressure, and volume are precisely controlled according to preset values based on empirically derived data or historic processing information.

The method S10 includes operation S13, in which the workpiece is sliced by at least one cutting member, and operation S14, in which an electric current is applied to the cutting member(s) and workpiece. Operations S13 and S14 may be executed simultaneously.

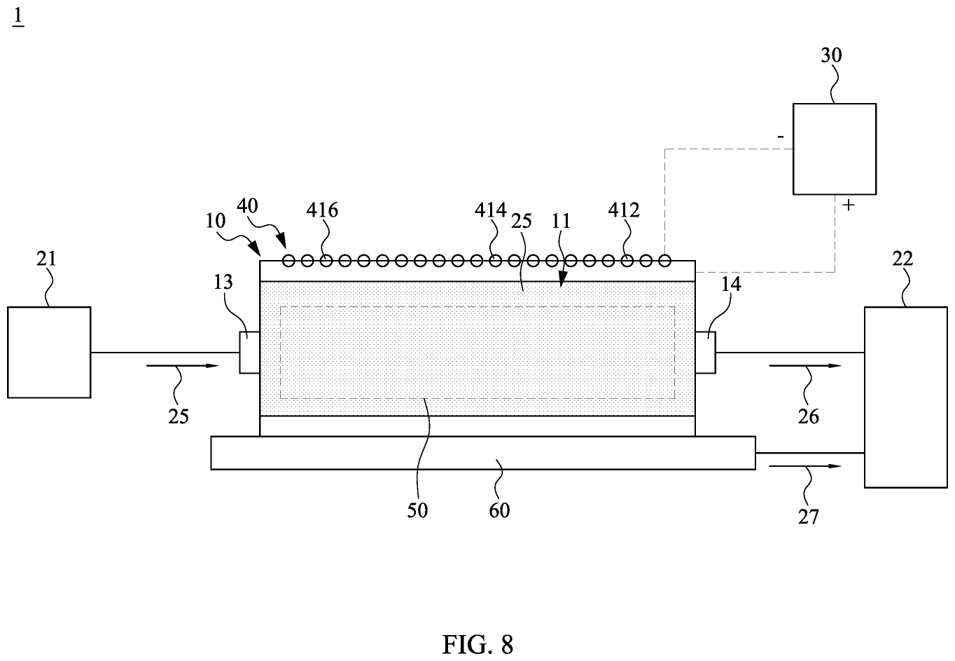

In some embodiments, as shown in FIG. 8, wires 412, 414, and 416 are used for slicing the mounted workpiece 50. The power supply module 30 applies a direct current (DC) to form a bias between the workpiece 50 and wires 412, 414, 416. In some embodiments, a positive bias is applied to the holding assembly 10, and a negative bias to the wires, so the holding assembly 10 or workpiece 50 serves as the anode and the wires as the cathode. The power supply module 30 may be a constant-voltage or constant-current supply, capable of providing 0-100 Watts power, 1-60V voltage, and 0-200 amp current. It may apply constant current or periodic pulses under 2.5 KHz. The periodic pulses can promote oxide layer formation on the wafer substrate. However, operating specifications vary by application.

In some embodiments, as shown in FIG. 8, when the wires 412, 414, 416 are lowered, they first contact the top surfaces of holding assembly 10. The wires 412, 414, 416 cut through the portions located between the workpiece 50 by using mechanical forces and abrasive action, and cuts 19 are formed at the holding assembly 10. For example, in FIGS. 2-3, the wires cut through the top portions of first and second side walls 124 and 125 before cutting the workpiece 50. In FIGS. 5-7, the wires cut through the top portions of upper holder 124a where supporting structure 153 is located before cutting the workpiece 50.

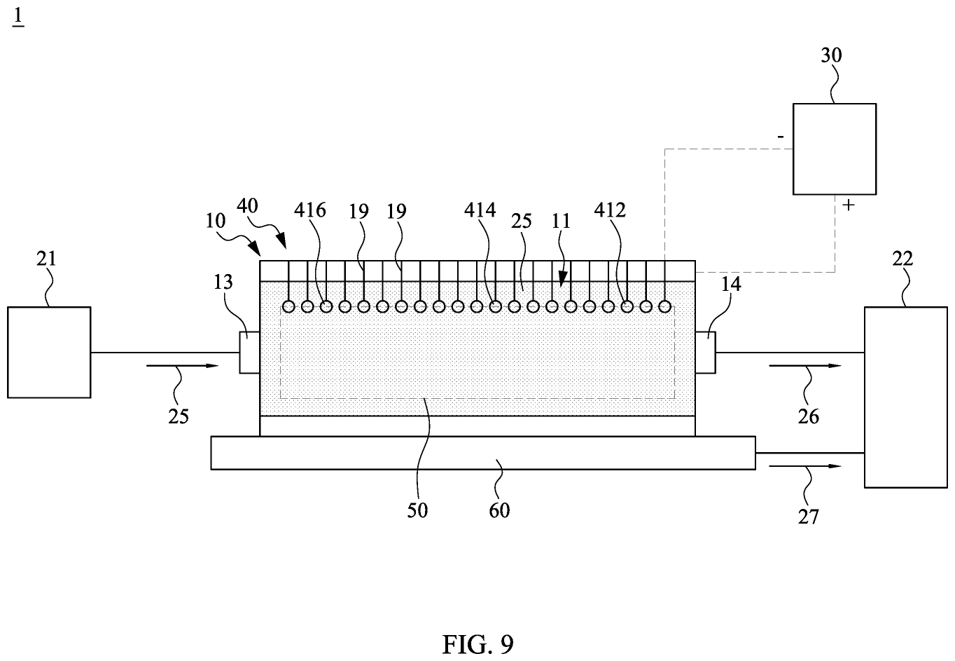

In some embodiments, as shown in FIG. 9, when further lowered to contact the workpiece 50, the wires 412, 414, 416 cut through the workpiece 50 and holding assembly 10 simultaneously. For example, in FIGS. 2-3, the wires cut through middle portion of the first and second side walls 124 and 125 while cutting the workpiece 50. In FIGS. 5-7, the wires cut through side portions of the upper holder 124a where supporting structure 152 and 154 are located while cutting the workpiece 50.

Since the electrolyte 25 fills the interior space 11, oxidation occurs at workpiece 50 contact points as electrons flow from the workpiece 50 to the wires 412, 414, 416 through the electrolyte 25. An oxide layer forms on the workpiece 50 surface and cuts formed in the workpiece 50. The oxide layer hardness is far less than the original material of the workpiece 50, so it can be quickly and easily removed. This advantageously leads to an extended wire lifetime, reduced impurity production, and mitigation of residual stress and surface defects in the sliced wafers.

In some embodiments, the circular cross-section wires 412, 414, 416 provide even electric field distribution, resulting in consistent oxide layer thickness within the cuts of workpiece 50. Compared to blades, this achieves better total thickness variation (TTV) in the sliced wafers. TTV measures thickness variation across a wafer. Low TTV enables higher device yield and performance.

In some embodiments, electrolyte 25 leaks from the holding assembly 10 when cuts 19 are formed within it. The waste liquid 27 mixing the leaked electrolyte and residue can be collected in tank 60 and sent to the electrolyte handling assembly 22 for processing. With continuous electrolyte supply, the electrochemical cutting process for the workpiece 50 will continue unaffected by leakage.

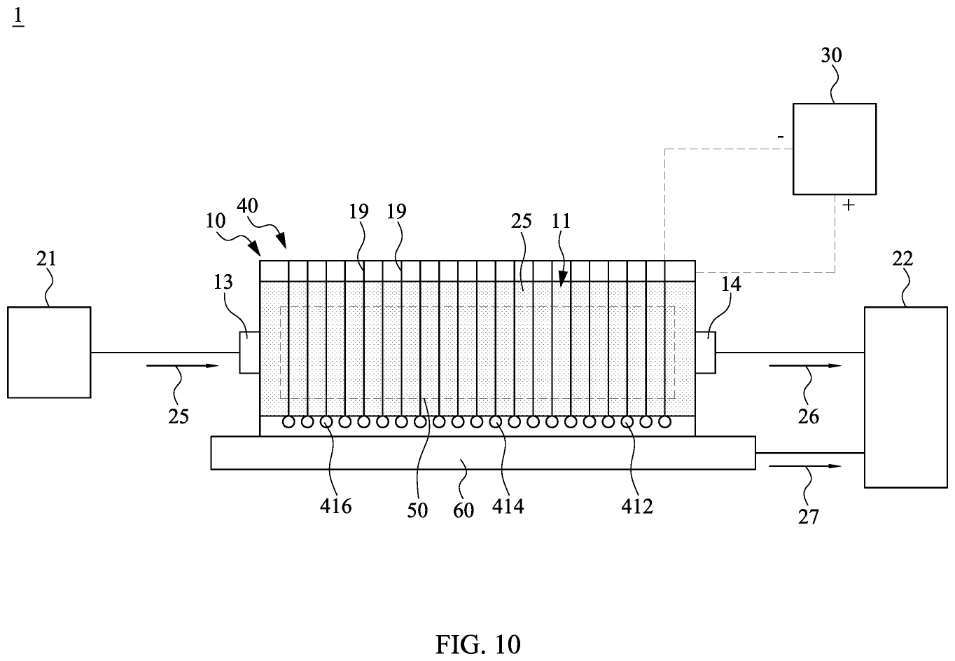

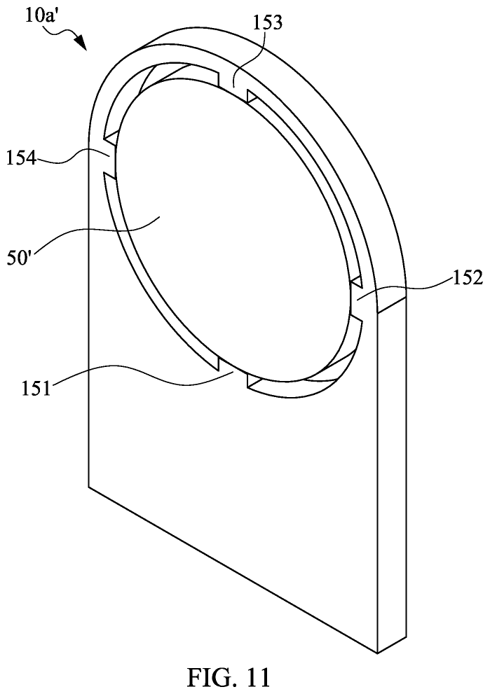

In some embodiments, as shown in FIG. 10, the movement of the wires 412, 414, 416 continues after the wires 412, 414, 416 travel through the workpiece 50. The wires may be further lowered to cut through all or part of the holding assembly. For example, in FIGS. 2-3, the wires cut through the bottom portion of the first and second side walls 124 and 125 including the supporting structure 15 after cutting the workpiece 50. In FIGS. 5-7, the wires cut through lower part of the upper holder 124a where the supporting structure 151 is located and the base 121a after cutting the workpiece 50. After completing the cutting process, as shown in FIG. 11, the sliced wafer 50′ is clamped by supporting structures 151, 152, 153, and 154 within the sliced holding assembly 10a′. The sliced wafer 50′, along with the sliced holding assembly 10a′, is then removed from the system. Due to the tight clamping by the supporting structures, the sliced wafer 50′ can be unloaded from the sliced holding assembly 10a′ by applying an external force.

With regard to the preceding description, it is to be understood that changes may be made in detail, especially in matters of the construction materials employed and the shape, size, and arrangement of parts without departing from the scope of the present disclosure. This specification and the embodiments described are exemplary only, with the true scope and spirit of the disclosure being indicated by the claims that follow.

What is claimed is:

1. A slicing system, comprising:
a holding assembly defining an interior space for receiving a workpiece;
an inlet port and an outlet port communicating with the interior space;
at least one cutting member configured to move relative to the holding assembly so as to slice the workpiece positioned in the interior space;
an electrolyte source connected to the inlet port, wherein an electrolyte is supplied from the electrolyte source to the interior space through the inlet port and existing the interior space through the outlet port; and
a power supply module configured to apply an electric current to the at least one cutting member and to the holding assembly.

2. The slicing system of claim 1, wherein a width of the inlet port is greater than a width of the outlet port.

3. The slicing system of claim 2, wherein a pressure inside the interior space becomes greater than a pressure at the inlet port when the interior space is filled with the electrolyte.

4. The slicing system of claim 1, wherein the holding assembly includes a front wall and a rear wall arranged along a longitudinal axis, the inlet port and the outlet port are positioned on the front wall and the rear wall, respectively.

5. The slicing system of claim 4, wherein the outlet port is arranged offset from the longitudinal axis.

6. The slicing system of claim 4, wherein the outlet port is positioned higher than the inlet port.

7. The slicing system of claim 4, wherein the inlet port and the outlet port are arranged aligning with the longitudinal axis.

8. The slicing system of claim 1, wherein the holding assembly comprises at least one supporting structure positioned within the interior space and configured to support the workpiece in the interior space.

9. The slicing system of claim 8, wherein the interior space of the holding assembly is defined by an inner wall, and the number of the supporting structures is plural, wherein each of the supporting structures is arranged on the inner wall and extends along a longitudinal axis.

10. The slicing system of claim 9, wherein the supporting structures are spaced apart in a circumferential direction of the inner wall at a constant pitch.

11. The slicing system of claim 1, wherein when the workpiece is positioned in the interior space, at least a portion of the holding assembly is positioned between the at least one cutting member and the workpiece.

12. The slicing system of claim 1, wherein the cutting member includes a wire having a circular cross-section.

13. The slicing system of claim 12, wherein the number of cutting members is plural, and the wires are arranged parallel to each other.

14. A slicing method, comprising:
loading a workpiece into an interior space of a holding assembly;
supplying an electrolyte to the interior space through an inlet port and discharging the electrolyte through an outlet port;
slicing the workpiece by at least one cutting member; and
applying an electric current to the at least one cutting member and to the workpiece.

15. The slicing method of claim 14, wherein a flow rate of the electrolyte through the outlet port is smaller than a flow rate of the electrolyte through the inlet port, and a higher pressure is established inside the interior space when the electrolyte is supplied into the interior space.

16. The slicing method of claim 14, wherein the electrolyte exits the interior space via the outlet port which is positioned higher than the inlet port.

17. The slicing method of claim 14, further comprising slicing a side wall of the holding assembly before slicing the workpiece.

18. The slicing method of claim 14, further comprising slicing a side wall of the holding assembly while slicing the workpiece.

19. The slicing method of claim 14, wherein the workpiece comprises a cylindrical ingot extending along a longitudinal axis, and the ingot is supported by a plurality of supporting structures surrounding a circumferential direction of the ingot and extending along the longitudinal axis.

20. The slicing method of claim 14, wherein the workpiece is sliced by the cutting member including a wire having a circular cross-section.
